(19) United States
(12) Patent Application Publication
(10) Pub. No.: US 2010/0276410 A1
(43) Pub. Date: Nov. 4, 2010

(54) LED LIGHTING SYSTEM AND METHOD FOR ANIMAL HABITAT

(76) Inventors: Andrew S. Hudson, Oak Creek, WI (US); Thomas R. Lutz, Franklin, WI (US); Phillip C. Bartoszek, New Berlin, WI (US); Christopher Michael Bourget, Fitchburg, WI (US); Thomas M. Crabb, Middleton, WI (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/773,088

(22) Filed: May 4, 2010

Related U.S. Application Data
(60) Provisional application No. 61/175,114, filed on May 4, 2009.

(51) Int. Cl. H05B 1/00; A01K 1/00; F21V 29/00; F21S 8/00; F21V 29/02

(52) U.S. Cl. 219/220; 250/504 R

(57) ABSTRACT

The present disclosure relates to a lighting system for providing ultraviolet (UV) light for use in an animal habitat that includes a light fixture housing that includes a plurality of LEDs, wherein one or more of the LEDs emit UVB light and wherein one or more of the LEDs emit UVA light, and where the LEDs are clustered together. The light fixture housing also includes a controller for setting and changing an amount of light provided by the LEDs that emit UVA light and the amount of light provided by the LEDs that emit UVB light.

### CROSS-REFERENCE TO RELATED APPLICATION(S)

The present utility patent application claims priority to U.S. Provisional Patent Application, Ser. No. 61/175,114, filed May 4, 2009; the subject matter of which is incorporated herein by reference in its entirety.

### FIELD OF THE INVENTION

The present invention relates generally to lighting systems and methods for animal habitat. More particularly, the present invention relates to light emitting diode (LED) lighting systems and methods for reptiles and/or other animals living in a captive environment, whereby the light may be provided via the lighting system at a level that substantially replicates the natural light environment of the particular animal and/or addresses the lighting needs of the animal.

### BACKGROUND OF THE INVENTION

Ultraviolet (UV) light is very important to the maintenance of reptiles and amphibians in captivity. UV light in the wavelengths between 295 and 300 nm is responsible for the production of Vitamin D₃ in the epidermis of reptiles, for example. Many reptiles are herbivores and are fed diets in captivity that lack sufficient vitamin D₃ activity. Unless supplemented with vitamin D₃, the animal can suffer from poor calcium and phosphorous absorption in the intestine and poor calcification in bones, which can lead to a degenerative disease condition called metabolic bone disease (MBD).

Besides dietary supplementation, another method for providing adequate vitamin D₃ is by providing UV light in the habitat so the animal can produce its own vitamin D₃ in the epidermis. To obtain vitamin D₃ via UV light in a cage, for example, the animal is required to lie under the UV lamp such that it can absorb the UV energy. Depending on the diet and natural habitat of the animal, the UVB requirement may be very different from that of another animal of a different species, for example. An animal such as the Bearded Dragon Pogonia vitticeps, for example, that is mainly herbivorous and is from a desert environment with a lot of exposure to tropical sunshine may have a very high UVB requirement. In contrast, a carnivorous reptile such as a Jackson's Chamaeleo jacksonii, from a tropical rainforest that typically lives in a very shaded environment may have a very low requirement for UVB energy in order to produce sufficient vitamin D₃, because it receives the bulk of its vitamin D₃ requirement from the insects it eats. Additionally, the Jackson's Chamaeleo has a thinner skin for easier absorption of UVB energy in lower light levels.

A need exists for a lighting system that may be calibrated by a user to provide a specific amount of UVA and/or UVB light.

### SUMMARY OF THE INVENTION

In some embodiments, the present disclosure provides a lighting system including Light-Emitting Diodes (LED) that may provide the proper amount of ultraviolet (UV) light, for example, required by reptiles in captivity by allowing a user to calibrate the amount of light provided.

In some embodiments of the present disclosure, a lighting system for providing ultraviolet (UV) light for use in an animal habitat, includes a light fixture housing that includes a plurality of LEDs, wherein one or more of the LEDs emit UVB light and wherein one or more of the LEDs emit UVA light, whereby the LEDs are clustered together. The light fixture housing also includes a controller for setting and changing the amount of light provided by the UVA LEDs and the amount of light provided by the UVB LEDs.

In another embodiment of the present disclosure, a heating system for use in an animal habitat includes a light fixture housing that includes a plurality of LEDs, wherein one or more of the LEDs emit heat via infrared light. The housing also includes a heat sink, and a controller for setting and changing the amount of heat provided by the LEDs that emit the heat via infrared light.

In still another embodiment of the present disclosure, a lighting system for providing ultraviolet (UV) light for use in an animal habitat comprises a light fixture housing that includes a plurality of LEDs, wherein one or more of the LEDs emit UVB light and wherein one or more of the LEDs emit UVA light. The light fixture housing also includes a heat source, wherein the LEDs and the heat source are clustered together at one end of the light fixture housing. The housing also includes a controller for setting and changing the amount of light provided by the UVA LEDs, the amount of light provided by the UVB LEDs, and the amount of heat provided by the heat source.

These and other features of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Also, it is appreciated that the configuration and arrangement of the heat sink, the LEDs, and the light fixture housing can be varied without departing from the scope of the present invention. Furthermore, it is appreciated that the invention concept, the detailed descriptions of LED lighting systems and methods thereof can be used for other animal habitat, such as tree frogs from Amazon Jungle, lizards from Sahara Desert, etc.

### BRIEF DESCRIPTION OF THE DRAWINGS

FIG. 1A illustrates a perspective view of one embodiment of a lighting system having a light fixture housing used with an animal enclosure, in accordance with the principles of the present invention.

FIG. 1B illustrates a perspective view of another embodiment of a lighting system having a light fixture housing used with an animal enclosure, in accordance with the principles of the present invention.

FIG. 2 illustrates a bottom view of the light fixture housing of the LED-based lighting system shown in FIG. 1.

FIG. 3 illustrates a cross sectional view of the light fixture housing of the LED-based lighting system shown in FIG. 1.

FIG. 4 illustrates a schematic view of a combination of UV LEDs and a heat source, in accordance with one embodiment of the present disclosure.

### DETAILED DESCRIPTION OF THE PREFERRED EMBODIMENTS

The ideal animal habitat may mimic the natural environment provided by the sun for a particular type of animal. For example, in the rainforest, the sun may be very intense at the top of a tree canopy all year round, whereas only a small percent of light may reach the rainforest floor due to the sun being blocked and/or absorbed before the light reaches the floor. Accordingly, an animal habitat for animals accustomed to a tree-top environment would ideally be very different from an animal habitat for animals accustomed to a forest floor environment, particularly in terms of lighting, e.g. Ultraviolet (UV) light.

Some embodiments of the present disclosure include providing UVB and/or UVA light in a lighting system such that the amount of UVB and/or UVA light can be controlled by a user to accommodate and provide for the specific lighting requirements of a specific animal. Generally, the lighting system may provide light in both the UVA (320-400 nm) wavelengths as well as the UVB (295-320 nm) wavelengths, for example, via the use of appropriate light sources, in some cases LEDs.

In addition to the benefits of UVB energy, there may also be benefits to providing UVA energy in the wavelengths between 320 and 400 nm, for example. Unlike human beings, which only have three types of cone cells for discerning color vision, reptiles have a fourth cone cell that is sensitive to wavelengths in the UVA range. Because of this, reptiles can see in the UVA wavelengths and are able to see UVA reflective markings and patterns that humans cannot. When illuminated with UVA radiation, captive reptiles may show increased social behavior and have stronger basking and feeding responses. Accordingly, it may be beneficial to provide UVA light in a lighting system for use with an animal enclosure.

Although there may be many benefits for reptiles being exposed to UV light, there are also harmful effects to UV light in the lower wavelengths, for example, less than 295 nm. These wavelengths in the low range UVB and UVC spectrums may cause harmful damage to the eyes and skin of an animal that may result in conditions such as photokeratoconjuntivits and burns and lesion to the skin. These harmful conditions can even be lethal to the reptile under severe exposure. In some embodiments of the present disclosure, an ideal amount of light may be provided to an animal in an animal habitat, where the generally ideal amount of light may include UVB, UVA, or UVB and UVA light at a level that is neither too high nor too low.

In still other embodiments, an ideal or appropriate amount of light may be provided via infrared LEDs and/or visible light LEDs, for example, as well as, or in addition to UVA and/or UVB light.

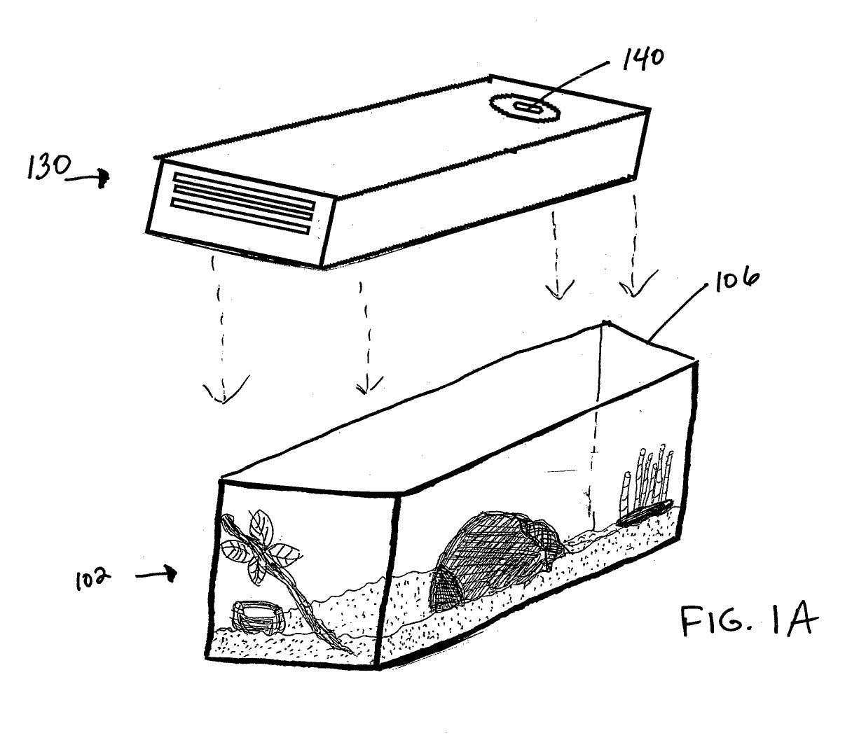

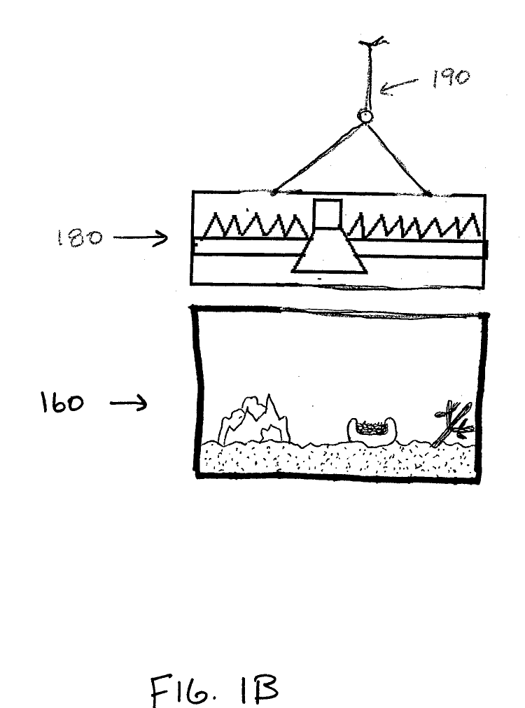

As shown in FIG. 1, the lighting system for animal habitat in some embodiments may include an animal enclosure 102, one or more light fixture housings 130, and in some embodiments a heat source 140. The animal enclosure 102 may be any suitable type of animal enclosure as appropriate for the type of animal housed therein, for example, but not limited to aquariums, terrariums, small cages, large cages, etc. The animal enclosure may be made of any suitable material, such as, for example, plastic, metal, glass, or any other suitable material, or combination of materials. The enclosure may also be of any suitable size, depending on the size of the animal housed therein, the species of the animal, and the amount of space that may be available for an animal enclosure, for example. Similarly, the enclosure may have any suitable shape, such as, for example, rectangular, cubed, hexagonal, or any other geometric shape.

Generally speaking, the enclosure may have a bottom, a top, and one or more side walls. As shown in FIG. 1, in some embodiments, the enclosure may have a top edge 106 that defines an opening on the top of the enclosure. In some embodiments, the enclosure may also include a cover that may be detachably secured to the top edge 106 of the enclosure by any suitable means, such as snap fit, tongue and groove connection, or any other suitable mechanism for detachably securing a cover to the enclosure. Generally, the cover may be of substantially the same size and shape as the shape defined by the top edge 106 of the enclosure. The cover may have an outside surface that when secured to the enclosure may face away from the interior of the enclosure, and the cover may also include an inside surface that when secured to the enclosure may face towards the interior of the enclosure.

In some embodiments, the light fixture housing 130 may be configured to be the cover, as shown in FIG. 1.

In other embodiments, the light fixture housing may be fixedly attached to the inside surface of the cover. In other embodiments, the lighting system may be detachably connectable to the inside surface of the cover. In still other embodiments, a light fixture housing 180 may be suspended from the top of an enclosure 160, as shown in FIG. 1B, for example, by strings, wires, hooks, 190 or any other method of suspending the light fixture housing 180 from the enclosure 160. In other embodiments, the fixture housing 180 may be supported over the enclosure 160. For example, in some embodiments, the enclosure 160 may not have a cover. In such an embodiment, the fixture housing 180 may be supported over the enclosure 160, by for example, a stand, or any other mechanism for supporting the fixture housing above the enclosure 160. In still other embodiments, the light fixture housing may be attached, either detachably or fixedly to the side wall or walls of the enclosure.

The light fixture housing, in some embodiments, may include at least one circuit board, heat sink, on-off switch, controller, fan, and/or a socket for a heat lamp.

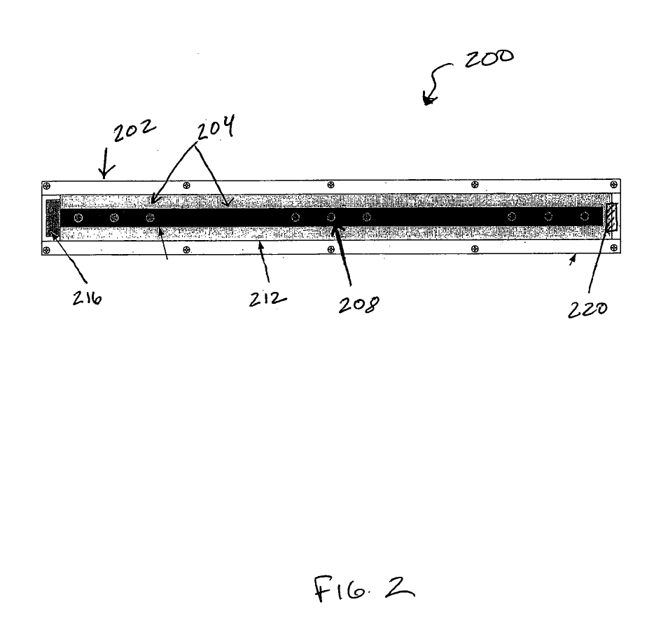

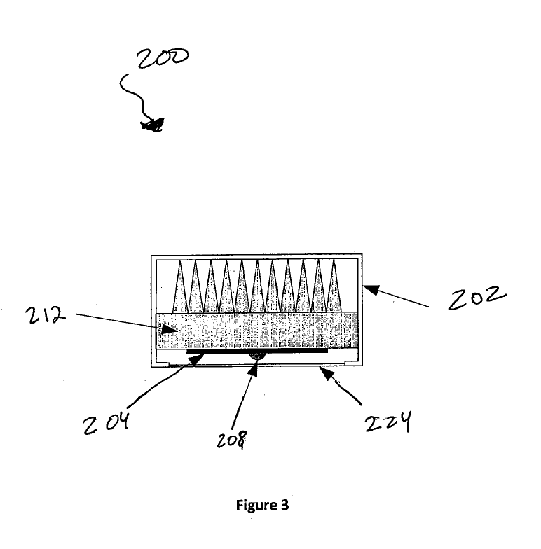

As may be seen in FIG. 2, a light fixture housing 202 for a lighting system 200 may generally contain and house some or all of the lighting system. The housing 202 may be comprised of any suitable material, such as, for example, plastic, metal, rubber, or any other suitable material, or combination of materials. The housing 202 may be of any suitable or desirable shape. For example, the housing may be generally rectangular, or it may be any shape that may suit the shape and dimensions of a particular enclosure. For example, the housing may be shaped like a square, oval, or any other geometric shape. As may be seen in FIG. 3, the housing may have a transparent window 224 that may allow the light to easily exit the light fixture housing 202.

In some embodiments, the light fixture housing may include a louvered top surface to allow heat to radiate off of a heat sink 212 (discussed further below) to the ambient air, for example.

The housing 202 may contain one or more circuit boards 204. The number of circuit boards 204 may be any number, and may depend, for example, on the size of the enclosure 106, 160, the species of animal in the enclosure 106, 160, and/or the number of animals in an enclosure 106, 160, for example. In some embodiments, one or more six inch circuit boards 204 may be positioned in the housing 202. In other embodiments, other sizes of circuit boards or combination of circuit board sizes may be used. In some embodiments, the circuit boards may be positioned within the housing in an end-to-end fashion. In other embodiments, the circuit boards may be connected side-to-side, or in any other suitable geometry.

Each circuit board may contain either UVA or UVB LEDs 208 in some embodiments. In some embodiments, the housing 202 may contain only UVA LEDs, while in other embodiments the housing 202 may contain only UVB LEDs. In still other embodiments, the housing may contain a combination of both UVA and UVB LEDs. Any ratio of UVA LEDs to UVB LEDs may be used. The ratio provided may depend, for example, on the type of animal living in the enclosure and the appropriate amount of UV light needed by the animal, for example. In some embodiments, the levels of UVA and UVB light in the lighting system may be configurable to allow different levels of UV light to be produced. For example, in some embodiments, this may be achieved by installing different numbers of UVA or UVB light modules in the housing during the manufacture of the lighting system. In other embodiments, infrared LEDs and/or visible light LEDs may be used, or may be used in addition to UVA and/or UVB LEDs. While the use of LEDs as a light source is disclosed, it will be recognized that other sources of light are possible and within the spirit and scope of this invention, for example, but not limited to, fluorescent and/or high-intensity discharge lamps.

In some embodiments, the light fixture housing 202 may contain the circuit boards 204 within a sealed area to protect the circuit boards 204 from environmental hazards that may be present, such as splashing water, for example, as well as to prevent the animal in an enclosure from coming into contact with the LEDs 208 or other components contained within the housing 202.

The lighting system 200 may also comprise a heat sink 212. In some embodiments, as shown in FIG. 2, the circuit boards 204 may be mounted to a heat sinking surface that may efficiently transfer heat generated by the circuit boards 204 into a fluid medium, for example air, by natural convection. The heat sink 212 may comprise, for example, aluminum, aluminum alloys, copper, diamond, or any other suitable substrate or combination of substrates. In some embodiments, a fan 216 may also be provided to direct the heated air out of the interior of the enclosure and toward the ambient air. In some embodiments, the light fixture housing 202 may also have a vent 220, whereby a fan 216 may blow the heated air across a length of the heat sink 212 and out the vent 220 at the other end of the light fixture housing 202. In other embodiments, the fan and/or the vent may be placed in any suitable arrangement within the light fixture housing.

The lighting system 200 may also comprise an on/off switch that may allow a user to turn the lighting system 200 on and off. The on/off switch may be of any kind known in the art, including a button, a toggle-switch, a chain, or any other method for turning the light system 200 on and off. The lighting system 200 may be powered by an external AC-to-DC power supply, in some embodiments. In other embodiments, any suitable power supply may be used, including but not limited to, batteries, solar power, alternators and/or generators, for example.

The lighting system 200 may also have a controller in some embodiments that may allow a user to set the amount of UVA and/or UVB light and/or any other types of light and/or heating sources provided in the light fixture housing that may emit from the lighting system. In some examples, the controller may allow a user to activate or deactivate one or more circuit boards to provide the appropriate amount of light to the animal. In some embodiments, the controller may have a timer that may allow a user to set the lights to turn on and/or off at specific times or after a certain amount of time. In other embodiments, one or more sensors may be provided in the enclosure that assesses the amount of light provided at the level of the animal and may automatically communicate with the controller so as to change the amount of light to provide a desired amount of light, that in some embodiments may be pre-set.

In another embodiment, a sensor or sensors disposed within the animal enclosure may communicate with a controller about the amount of light being provided to the animal. The controller may display that information. Based on the information provided, the user may change the settings on the controller to provide a desired amount of light. In some embodiments, the controller may be fixedly or detachably connected to the cover. In other embodiments, the controller may be affixed directly to the light fixture housing. In still other embodiments, the controller may be connected to the light fixture housing via a cord, while in still another embodiment the controller may be wirelessly connected to the fixture housing and/or one or more sensors via infrared, blue tooth, or any other suitable method.

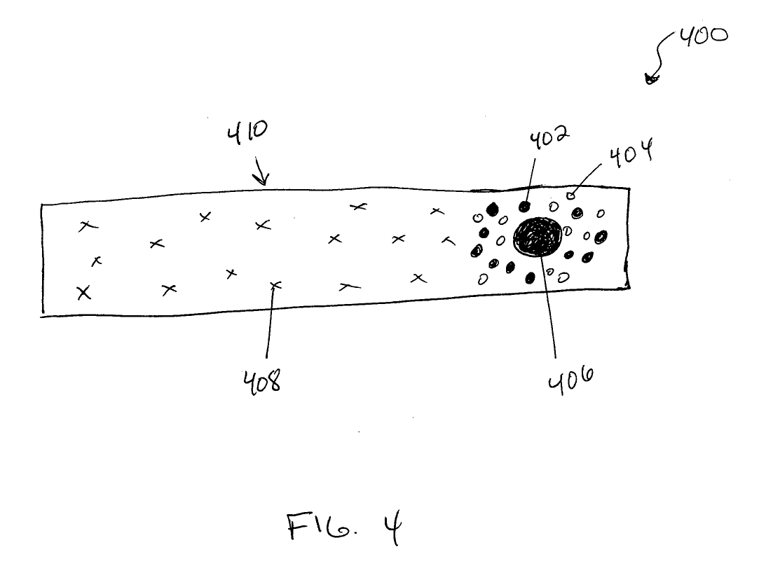

In another embodiment, the light fixture housing may also provide a means for producing heat. Reptiles may generally absorb UVB light when they are basking, and in order to bask, they may need a warm area that may be located in bright light. Bright light to a reptile may include visible light and UVA. As can be seen in FIG. 4, in some embodiments, the light fixture housing 410 may comprise a mixture of white light LEDs 408, UVA LEDs 404, UVB LEDs 402 and a heat source 406. In one embodiment, white light LEDs 408 may be generally evenly dispersed throughout the light fixture housing 410, while the UVB LEDs 402 and UVA LEDs 404 may be clustered together at one end of the light fixture housing 410, for example. In some embodiments, a heat source 406 may also be positioned at the end of the housing 410 where the UVA LEDs 404 and UVB LEDs 402 are clustered together. There may be a higher concentration of UVA 404 and/or UVB LEDs 402 in the area where they are clustered together with a heat source 406 than there are white light LEDs 408 in the remainder of the light fixture light housing 410. The term “clustered together” is hereby defined as UVA and UVB lights 402, 404 are arranged and disposed in concentration at positions, i.e. non-uniform in patterns, as opposed to uniformly spread across the light fixture housing, in some embodiments. It will be appreciated that other suitable arrangements of UV lights can be used without departing from the scope of the present invention. In addition, the white light LEDs 408, UVA LEDs 404, UVB LEDs 402 and/or the heat source 406 may be independently controllable in intensity. In embodiments of a light fixture housing 410 including a heat source 406, the UV lights 402, 404 and the heat source 406, for example a heat lamp, may be disposed on one side of the light fixture housing, for example, so the animal can thermo-regulate itself by moving to the opposite side of the enclosure when it needs to cool down. This embodiment may provide a gradient of heat, visible, and UV light, for example, from one side to the other by incorporating a heat source. In other embodiments any suitable or desirable arrangement of the UV lights, visible lights, and/or a heat source may be used.

In some embodiments, a heat sink may be used as a heat emitter. This may include mounting a fan above or within the heat sink to direct air flow so that it is aimed into the enclosure. This may direct the warm air toward a desired and/or a particular area that may become the animal's basking spot in the enclosure. The fan may be controllable by the controller, in some embodiments. For example, the controller may, in some embodiments, allow a user to direct the fan (and thus the hot air) toward a particular location and/or may allow a user to turn the fan on and/or off.

In still other embodiments, the lighting system may contain no UV LEDs, but instead may only contain, for example infrared LEDs, in order to provide heat to an animal in an enclosure. In still other embodiments, a lighting system may comprise any combination of UVA, UVB, and/or infrared LEDs.

Another embodiment may incorporate into the light fixture housing, a socket for an incandescent heat lamp, ceramic heat emitter, and/or halogen lamp, for example, in the lighting system in order to generate heat. In still other embodiments, the lighting system may incorporate LEDs as well as other types of light and/or heating sources (e.g. incandescent heat lamp, ceramic heat emitter, halogen lamp, etc.) in any suitable ratio. The advantages of a UV LED style lighting system over a typical fluorescent lighting system may include, but are not limited to, the ability to control the UV output as well as the creation of a UVB gradient.

In embodiments that comprise a heating source and a lighting source, the heating source may be independently controllable from the lighting source. In this way, the system may provide heat at night when it may be desirable to have no light, or conversely, it may be desirable to have light but no heat.

FIGS. 1-4 and descriptions show exemplary embodiments of the present invention. The drawings and detailed descriptions thereof are to be regarded as illustrative in nature and not restrictive.

What is claimed is:

1. A lighting system for providing ultraviolet (UV) light for use in an animal habitat, comprising:
a light fixture housing that includes a plurality of LEDs, wherein one or more of the LEDs emit UVB light and wherein one or more of the LEDs emit UVA light, whereby the LEDs are clustered together; and
a controller for setting and changing an amount of light provided by the UVA LEDs that emit UVA light and an amount of light provided by the LEDs that emit UVB light.

2. The lighting system of claim 1, wherein the lighting system provides the UVA light from the LEDs in wavelength of 320-400 nm, and the UVB light from the LEDs in wavelength of 295-320 nm.

3. The lighting system of claim 2, further comprising a heat sink whereby heat from the LEDs is transferred to the heat sink and then dissipated to ambient air via natural convection.

4. The lighting system of claim 2, further comprising a heat sink whereby heat from the LEDs is transferred to the heat sink and then dissipated to ambient air via a fan blowing across the heat sink.

5. The lighting system of claim 3, wherein for the natural convection, the light fixture housing includes a louvered top surface to allow heat to radiate off of the heat sink to the ambient air.

6. The lighting system of claim 4, wherein the fan is controllable by the controller.

7. The lighting system of claim 4, wherein the fan is mounted at one end of the light fixture housing and blows air across a length of the heat sink and out a vent at the other end of the light fixture housing.

8. The lighting system of claim 1, further comprising a power supply for the controller, and a timer.

9. The lighting system of claim 1, wherein the light fixture housing is connected to the animal habitat.

10. The lighting system of claim 9, further comprising a heat source, wherein the heat source is a heat sink, whereby a fan is mounted on the light fixture housing that directs heated air toward an interior of the animal habitat.

11. The lighting system of claim 2, further comprising a heat source.

12. A heating system for use in an animal habitat, comprising:
a light fixture housing that includes a plurality of LEDs and a heat sink, wherein one or more of the LEDs emit heat via infrared light; and
a controller for setting and changing an amount of the heat provided by the LEDs that emit the heat via the infrared light.

13. The heating system of claim 12, further comprising a fan mounted to the light fixture housing to direct heated air to a particular location.

14. A lighting system for providing ultraviolet (UV) light for use in an animal habitat, comprising:
a light fixture housing comprising a plurality of LEDs, wherein one or more of the LEDs emit UVB light and wherein one or more of the LEDs emit UVA light, and further comprising a heat source, wherein the LEDs and the heat source are clustered together at one end of the light fixture housing; and
a controller for setting and changing an amount of light provided by the LEDs that emit UVA light, an amount of light provided by the LEDs that emit UVB light, and an amount of heat provided by the heat source.

15. The lighting system of claim 14, wherein the LED-based lighting system provides the UVA light from the LEDs in wavelength of 320-400 nm, and the UVB light from the LEDs in wavelength of 295-320 nm.

16. The lighting system of claim 15, further comprising a heat sink whereby heat from the LEDs is transferred to the heat sink and then dissipated to ambient air via natural convection.

17. The lighting system of claim 15, further comprising a heat sink whereby heat from the LEDs is transferred to the heat sink and then dissipated to ambient air via a fan blowing across the heat sink.

18. The lighting system of claim 16, wherein for the natural convection, the light fixture housing includes a louvered top surface to allow heat to radiate off of the heat sink to the ambient air.

19. The lighting system of claim 16, wherein the light fixture housing is connected to the animal habitat.

20. The lighting system of claim 19, wherein the heat source is a heat sink, whereby a fan is mounted on the light fixture housing that directs heated air toward an interior of the animal habitat.
